(19) United States
(12) Patent Application Publication
(10) Pub. No.: US 2026/0340672 A1
(43) Pub. Date: Oct. 29, 2026

(54) PARK-FACTORY COORDINATED OPTIMIZATION SCHEDULING METHOD BASED ON JACOBI ITERATION ALGORITHM

(71) Applicant: YANSHAN UNIVERSITY, Qinhuangdao (CN)

(72) Inventors: Kai MA, Qinhuangdao (CN); Yanpei FENG, Qinhuangdao (CN); Jie YANG, Qinhuangdao (CN); Shiliang GUO, Qinhuangdao (CN); Yazhou YUAN, Qinhuangdao (CN); Hui LI, Qinhuangdao (CN); Haibin LI, Qinhuangdao (CN)

(73) Assignee: YANSHAN UNIVERSITY, Qinhuangdao (CN)

(21) Appl. No.: 19/706,501

(22) Filed: Jun. 12, 2026

Related U.S. Application Data
(63) Continuation of application No. PCT/CN2025/085000, filed on Mar. 26, 2025.

(30) Foreign Application Priority Data
Feb. 1, 2024 (CN) 202410141353.7

(51) Int. Cl. G06Q 30/0201; G06Q 10/04; G06Q 10/0631; G06Q 50/06

(52) U.S. Cl. CPC G06Q 30/0206; G06Q 10/04; G06Q 10/06315; G06Q 50/06

(57) ABSTRACT

In a park-factory coordinated optimization scheduling method based on a Jacobi iteration algorithm, a hierarchical game model between a park and a factory is established. Through coordinated optimization between energy scheduling under complex production constraints and production control aiming at profit optimization, an optimal price regulation and production scheduling strategy is obtained, so as to achieve lower energy consumption in an industrial park and higher production profits for the factory. A coordinated optimization scheduling model between a park control center and a factory control center constitutes a complex optimization problem with multiple variables and multiple constraints. For a numerical solution of a high-order partial differential equation system involved in the model, a cyclic iterative optimization algorithm is designed based on a Jacobi iteration matrix, which greatly reduces computational complexity. In addition, such a cyclic iterative algorithm requires less computer memory space, making it suitable for practical application by engineering personnel.

### CROSS-REFERENCE TO RELATED APPLICATIONS

This application is a continuation of International Patent Application No. PCT/CN2025/085000 with a filing date of Mar. 26, 2025, designating the United States, now pending, and further claims priority to Chinese Patent Application No. 202410141353.7 with a filing date of Feb. 1, 2024. The content of the aforementioned applications, including any intervening amendments thereto, is incorporated herein by reference.

### FIELD OF TECHNOLOGY

The present disclosure belongs to the technical field of energy optimization scheduling and relates to a park-factory coordinated optimization scheduling method based on a Jacobi iteration algorithm.

### BACKGROUND

Industrial electricity consumption accounts for 42.6% of global electricity usage. In recent years, the rapid development of smart grids and the accelerated electrification of the market have continuously raised new requirements for the energy structure configuration and production scheduling in industrial parks and associated electricity users. Based on this, industrial microgrids integrated with wind, solar, and energy storage have emerged. Owing to their complex and highly coupled configurations, energy consumption optimization not only requires effective control of industrial power loads but also the optimal scheduling of power generation and energy storage facilities within the park. Energy consumption in industrial parks is closely related to production processes. During energy scheduling of park microgrids, it is necessary to meet energy demands under complex production constraints. Meanwhile, optimal energy scheduling of the park microgrids and factory production load control are mutually restrictive and strongly coupled. Moreover, numerous studies have shown that market transaction mechanisms can enhance the interactivity of energy scheduling and reduce the operating costs of industrial parks. However, the introduction of such mechanisms, while improving system flexibility, further intensifies the coupling between park energy scheduling and production control. To reduce energy consumption costs in industrial parks and improve the economic benefits of factory production, it is necessary to design coordinated operation strategies that integrate energy scheduling with production control.

When game-based optimal scheduling is performed under park energy scheduling and factory production control, a large number of machines need to be scheduled, resulting in high-dimensional decision variables and complex constraints. For such game optimization problems with multidimensional and complex constraints, the design of an iterative optimization algorithm to obtain optimal park pricing and factory production scheduling strategies is key to achieving coordinated energy scheduling and production control.

### SUMMARY

A technical problem to be solved by the present disclosure is to propose a park-factory coordinated optimization scheduling method based on a Jacobi iteration algorithm. A cyclic iterative optimization algorithm for solving hierarchical models is designed based on the Jacobi iteration algorithm. Through coordinated optimization between energy scheduling under complex production constraints and production control aiming at profit maximization, an optimal price regulation and production scheduling strategy is obtained.

To achieve the above objective, a technical solution adopted by the present disclosure is as follows:

A park-factory coordinated optimization scheduling method based on a Jacobi iteration algorithm is provided and includes the following steps:
Step S1: establishing a coordinated optimization scheduling model for park entities and individual factories. A park control center aims to maximize comprehensive profit thereof, and is responsible for formulating a scheduling strategy for an energy storage device and power generation equipment within a park and formulating an electricity price strategy for external electricity purchase and factory electricity sales based on energy consumption data fed back by the factory control center, and a factory in the park receives an electricity price issued by the park control center, adjusts operating statuses of various machines in the factory, and formulates a new energy consumption plan to be fed back to the park control center. Based on the above process, a park-factory coordinated optimization scheduling model is constructed, mainly including a profit maximization model for the park control center and a profit maximization model for a factory control center.
Step S2: transforming a constrained optimization problem into an unconstrained optimization problem. It can be learned based on a park profit maximization model that optimization variables include transaction prices, external electricity purchase, charging/discharging of the energy storage device, and other unknown variables, and are constrained by characteristics of wind, solar, and energy storage and load power balance; and a Lagrange multiplier method and Karush-kuhn-Tucker (KKT) conditions are used to transform the constrained optimization problem of a park profit into the unconstrained problem thereof; and
Step S3: designing a cyclic iterative algorithm based on a Jacobi iteration matrix. The park profit maximization model is solved based on the Jacobi iteration algorithm; and then, a best response method is used to iteratively solve a hierarchical game model between the park control center and the factory control center, to obtain an optimal park pricing mechanism, an energy scheduling scheme, and a factory production scheduling strategy.

A further improvement of the technical solution of the present disclosure is that the establishing a coordinated optimization scheduling model for park entities and individual factories in Step S1 includes the following specific steps:
Step S11: acquiring initial parameters of the park control center and initial parameters of the factory control center, where the initial parameters of the park control center include a wind power generation forecast value, a photovoltaic power generation forecast value, an energy storage device capacity, a wind turbine maintenance cost, a photovoltaic panel maintenance cost, and an energy storage device maintenance cost; and the initial parameters of the factory control center include upper and lower limits of operating power for each machine in the factory;
Step S12: based on the initial parameters of the park control center and the initial parameters of the factory control center, constructing the park profit maximization model and a factory profit maximization model; and
Step S13: designing a park pricing mechanism to establish an interaction process between the park control center and the factory control center as a hierarchical game process, thereby constructing a park-factory hierarchical game model.

A further improvement of the technical solution of the present disclosure is that the transforming a constrained optimization problem into an unconstrained optimization problem in Step S2 includes the following specific steps:
Step S21: with an objective function and constraints of a park profit maximization problem being linear, equivalently solving the objective function through KKT conditions of the problem;
Step S22: introducing Lagrange multipliers respectively corresponding to inequality constraints and equality constraints, then writing a Lagrangian function for the park profit maximization problem; and
Step S23: based on the constructed Lagrangian function, obtaining equivalent KKT conditions of an initial problem.

A further improvement of the technical solution of the present disclosure is that the designing a cyclic iterative algorithm based on a Jacobi iteration matrix in Step S3 includes the following specific steps:
Step S31: solving a linear equation system AₛS_{p,s}=bₛ formed by equality KKT conditions based on the Jacobi iteration algorithm, with an iterative formula as follows:

$${S}_{p , s}^{* , ( z + 1 )} = {G}_{s} {S}_{p , s}^{* , ( z )} + {d}_{s} , z = 0 , 1 , … \qquad ( 1 )$$

where

$${S}_{p , s}^{* , ( 0 )}$$

is arbitrarily selected, and Gₛ is the Jacobi iteration matrix, with expressions of:

$${G}_{s} = - {D}_{s}^{- 1} ( {L}_{s} + {U}_{s} ) , {d}_{s} = {D}_{s}^{- 1} {b}_{s} .$$

Step S32: according to posterior inequality KKT conditions and parameters, screening obtained S optimal solutions S*_{p,s}, s∈[S] to finally obtain a park energy scheduling scheme:

$${S}_{p}^{*} = \{ {C}_{p}^{*} , {P}_{g}^{*} , {P}_{e}^{*} \} .$$

Step S33: using the best response method based on the Jacobi iteration algorithm to iteratively solve the hierarchical game model between the park control center and the factory control center.

Due to the use of the above technical solution, the technical improvement achieved by the present disclosure is that:

the coordinated optimization scheduling model between the park control center and the factory control center is a complex optimization problem with multiple variables and multiple constraints. For a numerical solution of a high-order partial differential equation system involved in the model, a cyclic iterative optimization algorithm is designed based on a Jacobi iteration matrix, which greatly reduces computational complexity. In addition, such a cyclic iterative algorithm requires less computer memory space, making it suitable for practical application by engineering personnel.

### BRIEF DESCRIPTION OF THE DRAWINGS

FIG. 1 is a flowchart of a cyclic iterative algorithm based on a Jacobi iteration matrix.

### DESCRIPTION OF THE EMBODIMENTS

A technical solution of the present disclosure will be described in detail below with reference to the accompanying drawings and embodiments:

A park-factory coordinated optimization scheduling method based on a Jacobi iteration algorithm is provided and includes:
Step S1: establishing a coordinated optimization scheduling model for park entities and individual factories. A park control center aims to maximize comprehensive profit thereof, and is responsible for formulating a scheduling strategy for an energy storage device and power generation equipment within a park and formulating an electricity price strategy for external electricity purchase and factory electricity sales based on energy consumption data fed back by the factory control center, and a factory in the park receives an electricity price issued by the park control center, adjusts operating statuses of various machines in the factory, and formulates a new energy consumption plan to be fed back to the park control center. Based on the above process, a park-factory coordinated optimization scheduling model is constructed, mainly including a profit maximization model for the park control center and a profit maximization model for a factory control center.
(1) Profit maximization model for a park control center: the park control center aims to minimize operation and maintenance costs as well as external electricity purchase costs. Its objective can be expressed as maximizing a profit function, namely, maximizing a profit from selling electricity to factories minus the operation and maintenance cost and external electricity purchase cost of the park, and the profit function is as follows:

$${S}_{r} = {\sum }_{t = 1}^{24} [ {C}_{p} ( t ) {P}_{fa} ( t ) - {C}_{g} ( t ) {P}_{g} ( t ) - {K}_{p} {P}_{p} ( t ) - {K}_{w} {P}_{w} ( t ) - {K}_{e} \vert {P}_{e} ( t ) ] \qquad ( 2 )$$

where P_{fa}(t) indicates electricity required for the factory at time t; P_{g}(t) indicates externally purchased electricity at time t; Kₚ, K_{w} and Kₑ are operation and maintenance cost coefficients of photovoltaic generation, wind power generation, and the energy storage device, respectively; Pₚ(t) and P_{w}(t) are forecast output values of photovoltaic and wind power for a next day, respectively; and Pₑ(t) indicates charging/discharging power of the energy storage device at time t.

Constraints of the profit maximization model for a park control center are as follows:

$${P}_{g}^{min} ( t ) \leq {P}_{g} ( t ) \leq {P}_{g}^{max} ( t ) \qquad ( 3 )$$

$${P}_{g} ( t ) + {P}_{p} ( t ) + {P}_{w} ( t ) + {P}_{e} ( t ) = {P}_{fa} ( t ) \qquad ( 4 )$$

$${P}_{e}^{min} ( t ) \leq {P}_{e} ( t ) \leq {P}_{e}^{max} ( t ) \qquad ( 5 )$$

$$SOC ( t + 1 ) = SOC ( t ) - \frac{η ( t ) {P}_{e} ( t )}{E} \qquad ( 6 )$$

SOC(0)=SOC(T) (7)

SOCₘᵢₙ≤SOC(t+1)≤SOCₘₐₓ (8)

equation (3) indicates that the externally purchased electricity of the park needs to meet upper and lower limit constraints; equation (4) indicates a supply-demand balance constraint of a park microgrid, where P_{fa}(t) indicates electric energy required for the factory at time t; equation (5) indicates upper and lower limit constraints of the charging/discharging power of the energy storage device, where Pₑ(t)>0 indicates charging of the energy storage device, Pₑ(t)<0 indicates discharging of the energy storage devices, and Pₑ(t)=0 indicates the device not operating; equation (6) is an introduced variable expression for a state of charge of the energy storage devices, where n(t) is charging/discharging efficiency of the energy storage devices, and E is a rated capacity of an energy storage devices; in an actual operation, to extend the service life of the energy storage devices, the state of charge needs to be constrained, as shown in equations (7) and (8), where equation (7) restricts the state of charge at the beginning and the end of a scheduling cycle to be equal, and equation (8) is upper and lower limit constraints of the state of charge.
(2) profit maximization model for a factory control center: the profit model for a factory control center is established based on a discrete manufacturing assembly system model, where the entire assembly line comprises M={M₁, M₂ . . . , M_{S-1}, M_{S}} processing machines and their associated material buffer area, as well as automatic guided vehicles. The assembly line includes s−1 processing production lines and one (s(th)) assembly production line. The objective of the profit model for the n(th) workshop of the factory control center is to maximize a product profit minus the cost of electricity externally purchased from the park and the penalty cost for failing to meet the expected processing target. The profit function is as follows:

$${U}_{w}^{n} = V - D - {C}_{p} ( t ) [ {\sum }_{t = 1}^{24} {\sum }_{i = 1}^{S} {\sum }_{j = 1}^{{M}_{i}} {P}_{a} {X}_{i}^{j} ( t ) - {\sum }_{t = 1}^{24} {\sum }_{i = 1}^{S - 1} {\sum }_{j = 1}^{{M}_{i}} {P}_{b} {Y}_{i}^{j} ( t ) - {\sum }_{t = 1}^{24} {\sum }_{j = 1}^{{M}_{S} - 1} {P}_{b} {Y}_{S}^{j} ( t ) ] \qquad ( 9 )$$

where V indicates a total profit from processed products in a scheduling cycle; D indicates a penalty cost for failing to meet an expected production quantity; Pₐ and P_{b} indicate rated power of processing machines and automated guided vehicles, respectively; and

$${X}_{i}^{j} ( t )$$

and

$${Y}_{i}^{j} ( t )$$

indicate an operating status of the processing machines and the automated guided vehicles at time t, respectively.

Constraints of the profit maximization model for a factory control center are as follows:
(1) definition of the operating status and a relationship of the processing machines and the automated guided vehicles:

$${X}_{i}^{j} ( t ) = \{ \begin{matrix}1 , processing machine on \\ 0 , processing machine off\end{matrix} \qquad ( 10 )$$

$${Y}_{i}^{j} ( t ) = \{ \begin{matrix}1 , automated guided vehicle on , \\ 0 , automated guided vehicle off ,\end{matrix} \qquad ( 11 )$$

where the status of each automated guided vehicle is required to be consistent with the operating status of a subsequent processing machine, and a relationship expression is as follows:

$${X}_{i}^{j + 1} ( t ) , i = 1 , 2 , … , S ; j = 1 , 2 , … , {M}_{i} - 1 \qquad ( 12 )$$

$${X}_{S}^{1} ( t ) , i = 1 , 2 , … , S - 1 ; j = {M}_{i} \qquad ( 13 )$$

$${Y}_{i}^{j - 1} ( t ) = {X}_{i}^{j} ( t ) , i = S ; j = {M}_{i} \qquad ( 14 )$$

(2) upper and lower limit constraints on an inventory capacity and a storage capacity of various material buffer areas:

$${B}_{i}^{j} ( t ) = {B}_{i}^{j} ( t - 1 ) + {n}_{i}^{j} ( t ) - {α}_{i}^{j} {n}_{i}^{j + 1} ( t ) , i = 1 , 2 , … , S ; j = 1 , 2 , … , {M}_{i} ; t = 2 , 3 , … , 24 ; \qquad ( 15 )$$

$${B}_{i}^{j} ( t ) = {B}_{i}^{j} ( t - 1 ) + {n}_{i}^{j} ( t ) - {α}_{i}^{j} {n}_{s}^{1} ( t ) , i = 1 , 2 , … , S - 1 ; j = {M}_{i} ; t = 2 , 3 , … , 24 ; \qquad ( 16 )$$

$${B}_{i}^{j} ( t ) = {B}_{i}^{j} ( t - 1 ) + {n}_{i}^{j} ( t ) , i = S ; j = {M}_{i} ; t = 2 , 3 , … , 24 ; \qquad ( 17 )$$

$${B}_{i}^{j} ( t ) ∈ {N}_{+} ; \qquad ( 18 )$$

$${B}_{i}^{j} ( t ) \leq B {max}_{i}^{j} \qquad ( 19 )$$

equation (15) indicates inventory capacity constraints of the material buffer areas on the preceding (s−1) processing lines, equations (16) and (17) indicate inventory capacity constraints of the material buffer area on an s(th) assembly line;

$${n}_{i}^{j} ( t )$$

indicates a quantity of workpieces possibly processed by the processing machine at time t; and a coefficient

$${α}_{i}^{j}$$

indicates that workpieces processed by the processing machines located downstream of the material buffer area must be supplied by the material buffer area;
(3) daily processing profit of a workshop:

$$V = {\sum }_{t} {\sum }_{i} {\sum }_{j} δ {B}_{i}^{j} ( t ) \qquad ( 20 )$$

where δ indicates the profit from the production of a single product; Bᵢ^{t}(t) indicates an inventory of a j(th) material buffer area on an i(th) production line at time t;
(4) penalty cost for failing to meet the expected production quantity:

$$D = {\sum }_{t} {\sum }_{i} {\sum }_{j} β ( d - {B}_{i}^{j} ( t ) ) \qquad ( 21 )$$

where d indicates an expected daily production quantity of products in the factory; and β indicates a penalty coefficient.
(5) park-factory load coupling model: a coupling relationship in a park-factory collaborative optimization model is mainly reflected in a fact that a load in a park microgrid comes from electricity required for operation of devices in various workshops of the factory, and a coupling relationship expression is as follows:

$${\sum }_{t = 1}^{24} {P}_{fa} ( t ) = {\sum }_{t = 1}^{24} {\sum }_{i = 1}^{S} {\sum }_{j = 1}^{{M}_{i}} {P}_{a} {X}_{i}^{j} ( t ) + {\sum }_{t = 1}^{24} {\sum }_{i = 1}^{S - 1} {\sum }_{j = 1}^{{M}_{i}} {P}_{b} {Y}_{i}^{j} ( t ) + {\sum }_{t = 1}^{24} {\sum }_{j = 1}^{{M}_{s} - 1} {P}_{b} {Y}_{S}^{j} ( t ) \qquad ( 22 )$$

where P_{fa}(t) indicates total electric energy required for the factory in the period t, which equals a sum of the electric energy required for operation of the processing machines, the automated guided vehicles, and other devices in the factory during the period.

According to the park-factory coordinated optimization scheduling model constructed in Step S1, the interaction process between the park control center and the factory control center is established as the hierarchical game process, and the game model is as follows:

$$G = \{ ( M ⋃ N ) ; ( {S}_{p} ⋃ {S}_{w} ) ; ( {S}_{r} ⋃ \{ {U}_{w}^{n} \} ) \} \qquad ( 23 )$$

meanings of elements in the model are as follows:
(1) game participants include two parties, where the park control center acts as a leader M in a game, and the factory control center acts as a follower N in the game;
(2) Sₚ={Cₚ(t), P_{g}(t), Pₑ(t)} indicates a park strategy set, including an electricity price sold to the factory and externally purchased electricity; and

$${S}_{w} = \{ {X}_{i}^{j} ( t ) , {y}_{i}^{j} ( t ) \}$$

indicates a factory strategy set, including the operating statuses of processing machines and automated guided vehicles; and
(3) Sᵣ indicates a profit function for the park control center, and U_{w}ⁿ indicates a profit function for an n(th) workshop in the factory.
Step S2: transforming a constrained optimization problem into an unconstrained optimization problem. It can be learned based on a park profit maximization model that optimization variables include transaction prices, external electricity purchase, charging/discharging of the energy storage device, and other unknown variables, and are constrained by characteristics of wind, solar, and energy storage and load power balance; and a Lagrange multiplier method and KKT conditions are used to transform the constrained optimization problem of a park profit into the unconstrained problem thereof, and a transformation process is as follows:
with an objective function and constraints of a park profit maximization problem being linear, the objective function is equivalently solved through KKT conditions of the problem. A compact form of a profit maximization problem for the park control center is expressed as:

min−Sᵣ(Sₚ)

s.t. gᵢ(Sₚ)≤0, i=1, . . . ,m

hⱼ(Sₚ)=0,j=1, . . . ,l (24)

in the formula, m indicates m inequality constraints, with corresponding Lagrange multipliers of λ={λᵢ}, and l indicates one equality constraint, with corresponding Lagrange multipliers of μ={μⱼ}.

A Lagrangian function of the above problem can be written as:

$$L ( {S}_{p} , λ , μ ) = - {S}_{r} ( {S}_{p} ) + {\sum }_{i = 1}^{m} {λ}_{i} {g}_{i} ( {S}_{p} ) + {\sum }_{j = 1}^{l} {μ}_{j} {h}_{j} ( {S}_{p} ) \qquad ( 25 )$$

Finally, the inequality constraints of the problem are transformed into the equality constraints using the KKT conditions and an extreme value is obtained by a differentiation method, and corresponding KKT conditions include:

$$- ∇ {S}_{r} ( {S}_{p}^{*} ) + {\sum }_{i = 1}^{m} {λ}_{i} ∇ {g}_{i} ( {S}_{p}^{*} ) + {\sum }_{j = 1}^{l} {μ}_{j} ∇ {h}_{j} ( {S}_{p}^{*} ) = 0 \qquad ( 26 )$$

$${λ}_{i} {g}_{i} ( {S}_{p}^{*} ) = 0 , i = 1 , … , m \qquad ( 27 )$$

$${h}_{j} ( {S}_{p}^{*} ) = 0 , j = 1 , … , l \qquad ( 28 )$$

$${λ}_{i} \geq 0 , i = 1 , … , m \qquad ( 29 )$$

$${g}_{i} ( {S}_{p}^{*} ) \leq 0 , i = 1 , … , m \qquad ( 30 )$$

where equation (26) indicates a necessary condition for the Lagrangian function to obtain a feasible solution; equation (27) indicates a complementary slackness condition, which specifies a relationship between whether the Lagrange multiplier is zero and the tightness of a corresponding constraint under optimal conditions; equations (28) and (30) indicate initial constraint conditions; and equation (29) indicates that the Lagrange multipliers of the inequality constraints need to be greater than or equal to zero.
Step S3: designing a cyclic iterative algorithm based on a Jacobi iteration matrix. The park profit maximization model is solved based on the Jacobi iteration algorithm; and then, a best response method is used to iteratively solve a hierarchical game model between the park control center and the factory control center, to obtain an optimal park pricing mechanism, an energy scheduling scheme, and a factory production scheduling strategy.

The designed cyclic iterative algorithm based on a Jacobi iteration matrix includes the following processes:
(1) according to Step S2, a case analysis is performed on whether Lagrange multiplier λᵢ is zero; and since there are m inequality constraints, a total of S=2^{m} cases are generated. In an s(th) case (s∈[S]), if a coefficient matrix of first three rows of equality conditions is Aₛ, s∈[S], and a constant matrix on a right side is bₛ. The coefficient matrix Aₛ can be decomposed into Aₛ=Dₛ+Lₛ+Uₛ, where Dₛ indicates a diagonal matrix composed of diagonal elements of Aₛ, Lₛ and Uₛ are strictly lower triangular matrix. For a linear equation system AₛS_{p,s}=bₛ formed by first three rows of equality KKT conditions in the s(th) case, the Jacobi iteration algorithm is used to obtain the optimal solution. The iterative formula is as follows:

$${S}_{p , s}^{* , ( z + 1 )} = {G}_{s} {S}_{p , s}^{* , ( z )} + {d}_{s} , z = 0 , 1 , … \qquad ( 31 )$$

where

$${S}_{p , s}^{* , ( 0 )}$$

is arbitrarily selected, and Gₛ is the Jacobi iteration matrix, with expressions of

$${G}_{s} = - {D}_{s}^{- 1} ( {L}_{s} + {U}_{s} ) , {d}_{s} = {D}_{s}^{- 1} {b}_{s} .$$

Next, according to last two rows of the inequality KKT conditions and the parameters, the obtained S optimal solutions

$${S}_{p , s}^{*} , s ∈ [ S ]$$

are screened to finally obtain the park energy scheduling scheme

$${S}_{p}^{*} = \{ {C}_{p}^{*} , {P}_{g}^{*} , {P}_{e}^{*} \} .$$

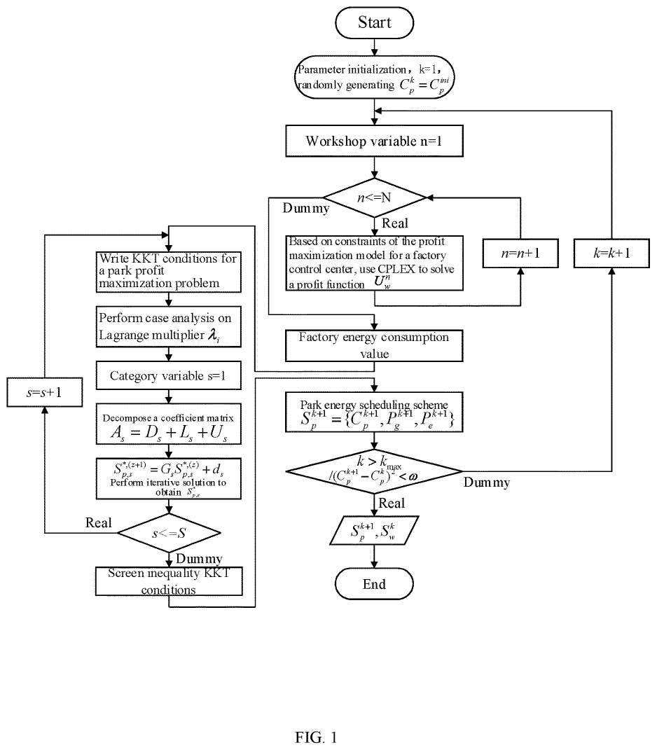

(2) Based on the above process, the best response method based on the Jacobi iteration algorithm is used to iteratively solve the park-factory hierarchical game model, the flowchart of the cyclic iterative algorithm is shown in FIG. 1, and the algorithm includes the following specific steps:
\textcircled{1} parameter initialization; setting the number of iterations k=1; and randomly generating a transaction electricity price

$${C}_{p}^{k} = {C}_{p}^{i n i} ;$$

\textcircled{2} based on constraints of the profit maximization model for a factory control center, using CPLEX to solve a profit function for each workshop

$${U}_{w}^{n}$$

to obtain the operating status of each machine in the factory

$${S}_{w}^{k} ;$$

\textcircled{3} calculating a factory energy composition value

$${P}_{f a}^{k}$$

according to a park-factory load coupling model;
\textcircled{4} solving the model based on the Jacobi iteration algorithm provided in Process (1) to obtain the park energy scheduling scheme

$${S}_{p}^{k + 1} = \{ {C}_{p}^{k + 1} , {P}_{g}^{k + 1} , {P}_{e}^{k + 1} \} ;$$

and
\textcircled{5} determining whether the number of iterations k>kₘₐₓ or

$${( {C}_{p}^{k + 1} - {C}_{p}^{k} )}^{2} < ω$$

is satisfied; if so, outputting a park pricing mechanism, an energy scheduling scheme, and a factory production scheduling strategy; if not, updating the number of iterations k=k+1 and returning to step \textcircled{2}.

In the present disclosure, the coordinated optimization scheduling model for park entities and individual factories is established, and a cyclic iterative optimization algorithm for solving hierarchical models is designed based on the Jacobi iteration algorithm. Through coordinated optimization between energy scheduling under complex production constraints and production control aiming at profit optimization, an optimal price regulation and production scheduling strategy are obtained, so as to achieve lower energy consumption in an industrial park and higher production profits for the factory. The coordinated optimization scheduling model between the park control center and the factory control center constitutes a complex optimization problem with multiple variables and multiple constraints. For the numerical solution of a high-order partial differential equation system involved in the model, a cyclic iterative optimization algorithm is designed based on a Jacobi iteration matrix, which greatly reduces computational complexity. In addition, such a cyclic iterative algorithm requires less computer memory space, making it suitable for practical application by engineering personnel.

What is claimed is:

1. A park-factory coordinated optimization scheduling method based on a Jacobi iteration algorithm, comprising the following steps:
step S1: establishing a coordinated optimization scheduling model for park entities and individual factories, wherein the coordinated optimization scheduling model comprises a profit maximization model for a park control center and a profit maximization model for a factory control center, the park control center is responsible for formulating a scheduling strategy for an energy storage device and power generation equipment within a park and formulating an electricity price strategy for external electricity purchase and factory electricity sales based on energy consumption data fed back by the factory control center, and a factory in the park receives an electricity price issued by the park control center, adjusts operating statuses of various machines in the factory, and formulates a new energy consumption plan to be fed back to the park control center;
step S2: transforming a constrained optimization problem into an unconstrained optimization problem, wherein it can be learned based on a park profit maximization model that optimization variables comprise transaction prices, external electricity purchase, charging/discharging of the energy storage device, and other unknown variables, and are constrained by characteristics of wind, solar, and energy storage and load power balance; and a Lagrange multiplier method and Karush-kuhn-Tucker (KKT) conditions are used to transform the constrained optimization problem of a park profit into the unconstrained problem thereof; and
step S3: designing a cyclic iterative algorithm based on a Jacobi iteration matrix, wherein the park profit maximization model is solved based on the Jacobi iteration algorithm; and then, a best response method is used to iteratively solve a hierarchical game model between the park control center and the factory control center, to obtain an optimal park pricing mechanism, an energy scheduling scheme, and a factory production scheduling strategy.

2. The park-factory coordinated optimization scheduling method according to claim 1, wherein the establishing a coordinated optimization scheduling model for park entities and individual factories in step S1 comprises the following specific steps:
step S11: acquiring initial parameters of the park control center and initial parameters of the factory control center, where the initial parameters of the park control center include a wind power generation forecast value, a photovoltaic power generation forecast value, an energy storage device capacity, a wind turbine maintenance cost, a photovoltaic panel maintenance cost, and an energy storage device maintenance cost; and the initial parameters of the factory control center include upper and lower limits of operating power for each machine in the factory;
step S12: based on the initial parameters of the park control center and the initial parameters of the factory control center, constructing the park profit maximization model and a factory profit maximization model; and
step S13: designing a park pricing mechanism to establish an interaction process between the park control center and the factory control center as a hierarchical game process, thereby constructing a park-factory hierarchical game model.

3. The park-factory coordinated optimization scheduling method according to claim 1, wherein the transforming a constrained optimization problem into an unconstrained optimization problem in step S2 comprises the following specific steps:
step S21: with an objective function and constraints of a park profit maximization problem being linear, equivalently solving the objective function through KKT conditions of the problem;
step S22: introducing Lagrange multipliers respectively corresponding to inequality constraints and equality constraints, then writing a Lagrangian function for the park profit maximization problem; and
step S23: based on the constructed Lagrangian function, obtaining equivalent KKT conditions of an initial problem.

4. The park-factory coordinated optimization scheduling method according to claim 2, wherein the designing a cyclic iterative algorithm based on a Jacobi iteration matrix in step S3 comprises the following specific steps:
step S31: solving a linear equation system AₛS_{p,s}=bₛ formed by equality KKT conditions based on the Jacobi iteration algorithm, with an iterative formula as follows:
$${S}_{p , s}^{* , ( z + 1 )} = {G}_{s} {S}_{p s}^{* , ( z )} + {d}_{s} , z = 0 , 1 , … \qquad ( 1 )$$
wherein
$${S}_{p , s}^{* , ( 0 )}$$
is arbitrarily selected, and Gₛ is the Jacobi iteration matrix, with expressions of Gₛ=−Dₛ⁻¹(Lₛ+Uₛ), dₛ=Dₛ⁻¹bₛ;
step S32: according to posterior inequality KKT conditions and parameters, screening obtained S optimal solutions
$${S}_{p , s}^{*} , s ∈ [ S ]$$
to finally obtain a park energy scheduling scheme
$${S}_{p}^{*} = \{ {C}_{p}^{*} , {P}_{g}^{*} , {P}_{e}^{*} \} ;$$
and
step S33: using the best response method based on the Jacobi iteration algorithm to iteratively solve the hierarchical game model between the park control center and the factory control center.

5. The park-factory coordinated optimization scheduling method according to claim 2, wherein in the profit maximization model for a park control center, a profit function is as follows:
$${S}_{r} = {\sum }_{t = 1}^{24} [ {C}_{p} ( t ) {P}_{f a} ( t ) - {C}_{g} ( t ) {P}_{g} ( t ) - {K}_{p} {P}_{p} ( t ) - {K}_{w} {P}_{w} ( t ) - {K}_{e} \vert {P}_{e} ( t ) ] \qquad ( 2 )$$
wherein P_{fa}(t) indicates electricity required for the factory at time t; P_{g}(t) indicates externally purchased electricity at time t; Kₚ, K_{w} and Kₑ are operation and maintenance cost coefficients of photovoltaic generation, wind power generation, and the energy storage device, respectively; Pₚ(t) and P_{w}(t) are forecast output values of photovoltaic and wind power for a next day, respectively; and Pₑ(t) indicates charging/discharging power of the energy storage device at time t; and
constraints of the profit maximization model for a park control center are as follows:
$${P}_{g}^{min} ( t ) \leq {P}_{g} ( t ) \leq {P}_{g}^{max} ( t ) \qquad ( 3 )$$
P_{g}(t)+Pₚ(t)+P_{w}(t)+Pₑ(t)=P_{fa}(t) (4)
$${P}_{e}^{min} ( t ) \leq {P}_{e} ( t ) \leq {P}_{e}^{max} ( t ) \qquad ( 5 )$$
$$SOC ( t + 1 ) = SOC ( t ) - \frac{η ( t ) {P}_{e} ( t )}{E} \qquad ( 6 )$$
SOC(0)=SOC(T) (7)
SOCₘᵢₙ≤SOC(t+1)≤SOCₘₐₓ (8)
equation (3) indicates that the externally purchased electricity of the park needs to meet upper and lower limit constraints; equation (4) indicates a supply-demand balance constraint of a park microgrid, where P_{fa}(t) indicates electric energy required for the factory at time t; equation (5) indicates upper and lower limit constraints of the charging/discharging power of the energy storage device, where Pₑ(t)>0 indicates charging of the energy storage device, Pₑ(t)<0 indicates discharging of the energy storage devices, and Pₑ(t)=0 indicates the device not operating; equation (6) is an introduced variable expression for a state of charge of the energy storage devices, where n(t) is charging/discharging efficiency of the energy storage devices, and E is a rated capacity of an energy storage devices; in an actual operation, to extend the service life of the energy storage devices, the state of charge needs to be constrained, as shown in equations (7) and (8), where equation (7) restricts the state of charge at the beginning and the end of a scheduling cycle to be equal, and equation (8) is upper and lower limit constraints of the state of charge.

6. The park-factory coordinated optimization scheduling method according to claim 2, wherein in the profit maximization model for a factory control center, a profit function is as follows:
$${U}_{w}^{n} = V - D - {C}_{p} ( t ) [ {\sum }_{t = 1}^{24} {\sum }_{i = 1}^{S} {\sum }_{j = 1}^{{M}_{i}} {P}_{a} {X}_{i}^{j} ( t ) - {\sum }_{t = 1}^{24} {\sum }_{i = 1}^{S - 1} {\sum }_{j = 1}^{{M}_{i}} {P}_{b} {Y}_{i}^{j} ( t ) - {\sum }_{t = 1}^{24} {\sum }_{j = 1}^{{M}_{S - 1}} {P}_{b} {Y}_{S}^{j} ( t ) ] \qquad ( 9 )$$
wherein V indicates a total profit from processed products in a scheduling cycle;
D indicates a penalty cost for failing to meet an expected production quantity; Pₐ and P_{b} indicate rated power of processing machines and automated guided vehicles, respectively; and Xᵢ^{j}(t) and Yᵢ^{j}(t) indicate an operating status of the processing machines and the automated guided vehicles at time t, respectively; and
constraints of the profit maximization model for a factory control center are as follows:
(1) definition of the operating status and a relationship of the processing machines and the automated guided vehicles:
$${X}_{i}^{j} ( t ) = \{ \begin{matrix}1 , processing machine on \\ 0 , processing machine off\end{matrix} \qquad ( 10 )$$
$${Y}_{i}^{j} ( t ) = \{ \begin{matrix}1 , & automated guided vehicle on \\ 0 , & automated guidedv ehicle off\end{matrix} \qquad ( 11 )$$
where the status of each automated guided vehicle is required to be consistent with the operating status of a subsequent processing machine, and a relationship expression is as follows:
xᵢ^{j+1}(t),i=1,2, . . . ,S;j=1,2, . . . ,Mᵢ−1 (12)
$${X}_{S}^{1} ( t ) , i = 1 , 2 , … , S - 1 ; j = {M}_{i} \qquad ( 13 )$$
$${Y}_{i}^{j - 1} ( t ) = {X}_{i}^{j} ( t ) , i = S ; j = {M}_{i} \qquad ( 14 )$$
(2) upper and lower limit constraints on an inventory capacity and a storage capacity of various material buffer areas:
$${B}_{i}^{j} ( t ) = {B}_{i}^{j} ( t - 1 ) + {n}_{i}^{j} ( t ) - {α}_{i}^{j} {n}_{i}^{j + 1} ( t ) , \qquad ( 15 )$$
$$i = 1 , 2 , … , S ; j = 1 , 2 , … , {M}_{i} ; t = 2 , 3 , … , 24 ;$$
$${B}_{i}^{j} ( t ) = {B}_{i}^{j} ( t - 1 ) + {n}_{i}^{j} ( t ) - {α}_{i}^{j} {n}_{s}^{1} ( t ) , \qquad ( 16 )$$
$$i = 1 , 2 , … , S - 1 ; j = {M}_{i} ; t = 2 , 3 , … , 24 ;$$
$${B}_{i}^{j} ( t ) = {B}_{i}^{j} ( t - 1 ) + {n}_{i}^{j} ( t ) , i = S ; j = {M}_{i} ; t = 2 , 3 , … , 24 ; \qquad ( 17 )$$
$${B}_{i}^{j} ( t ) ∈ {N}_{+} ; \qquad ( 18 )$$
$${B}_{i}^{j} ( t ) \leq B {max}_{i}^{j} \qquad ( 19 )$$
equation (15) indicates inventory capacity constraints of the material buffer areas on the preceding (s−1) processing lines, equations (16) and (17) indicate inventory capacity constraints of the material buffer area on an s(th) assembly line; nᵢ^{j}(t) indicates a quantity of workpieces possibly processed by the processing machine at time t; and a coefficient αᵢ^{j} indicates that workpieces processed by the processing machines located downstream of the material buffer area must be supplied by the material buffer area;
(3) daily processing profit of a workshop:
$$V = {\sum }_{t} {\sum }_{i} {\sum }_{j} δ {B}_{i}^{j} ( t ) \qquad ( 20 )$$
wherein δ indicates a profit from production of a single product; Bᵢ^{j}(t) indicates an inventory of a j(th) material buffer area on an i(th) production line at time t;
(4) penalty cost for failing to meet the expected production quantity:
$$D = {\sum }_{t} {\sum }_{i} {\sum }_{j} β ( d - {B}_{i}^{j} ( t ) ) \qquad ( 21 )$$
wherein d indicates an expected daily production quantity of products in the factory; and β indicates a penalty coefficient; and
(5) park-factory load coupling model: a coupling relationship in a park-factory collaborative optimization model is mainly reflected in a fact that a load in a park microgrid comes from electricity required for operation of devices in various workshops of the factory, and a coupling relationship expression is as follows:
$${\sum }_{t = 1}^{24} {P}_{f a} ( t ) = {\sum }_{t = 1}^{24} {\sum }_{i = 1}^{S} {\sum }_{j = 1}^{{M}_{i}} {P}_{a} {X}_{i}^{j} ( t ) + {\sum }_{t = 1}^{24} {\sum }_{i = 1}^{S - 1} {\sum }_{j = 1}^{{M}_{i}} {P}_{b} {Y}_{i}^{j} ( t ) + {\sum }_{t = 1}^{24} {\sum }_{j = 1}^{{M}_{s} - 1} {P}_{b} {Y}_{S}^{j} ( t ) \qquad ( 22 )$$
wherein P_{fa}(t) indicates total electric energy required for the factory in the period t, which equals a sum of the electric energy required for operation of the processing machines, the automated guided vehicles, and other devices in the factory during the period.

7. The park-factory coordinated optimization scheduling method according to claim 2, wherein in Step S13, the interaction process between the park control center and the factory control center is established as the hierarchical game process, and the game model is as follows:
$$G = \{ ( M ⋃ N ) ; ( {S}_{p} ⋃ {S}_{w} ) ; ( {S}_{r} ⋃ \{ {U}_{w}^{n} \} ) \} \qquad ( 23 )$$
meanings of elements in the model are as follows:
(1) game participants comprise two parties, wherein the park control center acts as a leader M in a game, and the factory control center acts as a follower N in the game;
(2) Sₚ={Cₚ(t), P_{g}(t), Pₑ(t)} indicates a park strategy set, including an electricity price sold to the factory and externally purchased electricity; and
$${S}_{w} = \{ {X}_{i}^{j} ( t ) , {Y}_{i}^{j} ( t ) \}$$
indicates a factory strategy set, including the operating statuses of processing machines and automated guided vehicles; and
(3) Sᵣ indicates a profit function for the park control center, and
$${U}_{w}^{n}$$
indicates a profit function for an n(th) workshop in the factory.

8. The park-factory coordinated optimization scheduling method according to claim 3, wherein a compact form of a profit maximization problem for the park control center is expressed as:
min−Sᵣ(Sₚ)
s.t. gᵢ(Sₚ)≤0, i=1, . . . ,m
hⱼ(Sₚ)=0, j=1, . . . ,l (24)
in the formula, m indicates m inequality constraints, with corresponding Lagrange multipliers of λ={λᵢ}, and l indicates one equality constraint, with corresponding Lagrange multipliers of μ={μⱼ};
a Lagrangian function for the problem is as follows:
$$L ( {S}_{p} , λ , μ ) = - {S}_{r} ( {S}_{p} ) + {\sum }_{i = 1}^{m} {λ}_{i} {g}_{i} ( {S}_{p} ) + {\sum }_{j = 1}^{l} {μ}_{j} {h}_{j} ( {S}_{p} ) \qquad ( 25 )$$
the inequality constraints of the problem are transformed into the equality constraints using the KKT conditions and an extreme value is obtained by a differentiation method, and corresponding KKT conditions comprise:
$$- ∇ {S}_{r} ( {S}_{p}^{*} ) + {\sum }_{i = 1}^{m} {λ}_{i} ∇ {g}_{i} ( {S}_{p}^{*} ) + {\sum }_{j = 1}^{l} {μ}_{j} ∇ {h}_{j} ( {S}_{p}^{*} ) = 0 \qquad ( 26 )$$
$${λ}_{i} {g}_{i} ( {S}_{p}^{*} ) = 0 , i = 1 , … , m \qquad ( 27 )$$
$${h}_{j} ( {S}_{p}^{*} ) = 0 , j = 1 , … , l \qquad ( 28 )$$
$${λ}_{i} \geq 0 , i = 1 , … , m \qquad ( 29 )$$
$${g}_{i} ( {S}_{p}^{*} ) \leq 0 , i = 1 , … , m \qquad ( 30 )$$
wherein equation (26) indicates a necessary condition for the Lagrangian function to obtain a feasible solution; equation (27) indicates a complementary slackness condition, which specifies a relationship between whether the Lagrange multiplier is zero and the tightness of a corresponding constraint under optimal conditions; equations (28) and (30) indicate initial constraint conditions; and equation (29) indicates that the Lagrange multipliers of the inequality constraints need to be greater than or equal to zero.

9. The park-factory coordinated optimization scheduling method according to claim 4, wherein the best response method based on a Jacobi iteration algorithm is used to iteratively solve the park-factory hierarchical game model, and a specific process of the cyclic iterative algorithm is as follows:
process 1: according to the KKT conditions constructed for a profit maximization problem for the park control center, a case analysis is performed on whether Lagrange multipliers λᵢ are zero; since there are m inequality constraints, there are S=2^{m} possible cases in total; in an s(th) case, s∈[S], if a coefficient matrix of first three rows of equality conditions is Aₛ, s∈[S], and a constant matrix on a right side is bₛ, the coefficient matrix Aₛ is possibly decomposed into Aₛ=Dₛ+Lₛ+Uₛ, wherein Dₛ indicates a diagonal matrix composed of diagonal elements of Aₛ, Lₛ is a strictly lower triangular matrix, and Uₛ is a strictly lower triangular matrix; and for a linear equation system AₛS_{p,s}=bₛ formed by first three rows of equality KKT conditions in the s(th) case, an optimal solution is obtained based on the Jacobi iteration algorithm, and an iterative formula is as follows:
$${S}_{p , s}^{* , ( z + 1 )} = {G}_{s} {S}_{p , s}^{* , ( z )} + {d}_{s} , z = 0 , 1 , … \qquad ( 31 )$$
wherein
$${S}_{p , s}^{* , ( 0 )}$$
is arbitrarily selected, and Gₛ is the Jacobi iteration matrix, with expressions of
$${G}_{s} = - {D}_{s}^{- 1} ( {L}_{s} + {U}_{s} ) , {d}_{s} = {D}_{s}^{- 1} {b}_{s} ;$$
according to last two rows of the inequality KKT conditions and the parameters, the obtained S optimal solutions
$${S}_{p , s}^{*} , s ∈ [ S ]$$
are screened to finally obtain the park energy scheduling scheme
$${S}_{p}^{*} = \{ {C}_{p}^{*} , {P}_{g}^{*} , {P}_{e}^{*} \} ;$$
process 2: based on Process 1, the best response method based on a Jacobi iteration algorithm is used to iteratively solve the park-factory hierarchical game model, and the algorithm comprises the following specific steps:
\textcircled{1} parameter initialization; setting the number of iterations k=1; and randomly generating a transaction electricity price
$${C}_{p}^{k} = {C}_{p}^{i n i} ;$$
\textcircled{2} based on constraints of the profit maximization model for a factory control center, using CPLEX to solve a profit function
$${U}_{w}^{n}$$
for each workshop to obtain the operating status
$${S}_{w}^{k}$$
of each machine in the factory;
\textcircled{3} calculating a factory energy consumption value
$${P}_{f a}^{k}$$
according to a park-factory load coupling model;
\textcircled{4} solving the model based on the Jacobi iteration algorithm provided in Process 1 to obtain the park energy scheduling scheme
$${S}_{p}^{k + 1} = \{ {C}_{p}^{k + 1} , {P}_{g}^{k + 1} , {P}_{e}^{k + 1} \} ;$$
and
\textcircled{5} determining whether the number of iterations k>kₘₐₓ or (Cₚ^{k+1}−Cₚ^{k})²<ω is satisfied; if so, outputting a park pricing mechanism, an energy scheduling scheme, and a factory production scheduling strategy; if not, updating the number of iterations k=k+1 and returning to step \textcircled{2}.
